(19) United States
(12) Patent Application Publication
(10) Pub. No.: US 2004/0158358 A1
(43) Pub. Date: Aug. 12, 2004

(54) Method of teaching traveling path to robot and robot having function of learning traveling path

(75) Inventors: Takashi Anezaki, Hirakata-shi (JP); Tamao Okamoto, Nishinomiya-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Electric Industrial Co., Ltd., Kadoma-shi (JP)

(21) Appl. No.: 10/772,278

(22) Filed: Feb. 6, 2004

(30) Foreign Application Priority Data
Feb. 6, 2003 (JP) 2003-028949

(51) Int. Cl. G06F 19/00

(52) U.S. Cl. 700/264; 700/245

(57) ABSTRACT

In a method of teaching a traveling path to a robot, when a self-propelled robot learns a traveling path, automatic processing is performed as follows: an instructor only follows the traveling path, and the self-propelled robot set at a learning mode follows the traveling path of the instructor and determines path teaching data. Thus, it is possible to teach a path to the self-propelled robot without the necessity for the instructor to directly edit position data.

### FIELD OF THE INVENTION

The present invention relates to a method of teaching a traveling path to a self-propelled (autonomously moving) robot and a robot having the function of learning a traveling path.

### BACKGROUND OF THE INVENTION

Conventionally in the field of navigation systems assisting the driving of automobiles, the following are known: a measuring section which stores map data and measures the position of an automobile at each predetermined time, a control section which sets a display area on the map based on the position measured by the measuring section, a processing section which generates a display signal of the map based on the map data read according to the display area set by the control section, and a device which performs control such that the display area on the displayed map is gradually changed from the previously measured position to the subsequently measured position according to the control of the control section.

As a conventional example of a method of teaching an operation to a robot, the following method is known: a path teaching device is provided which teaches, to a path following device, a path to be followed by the end of an operating tool and displays an actual teaching state on a path teach window, a posture teaching device is provided which teaches, to the path following device, a posture to be followed by the operating tool and displays an actual teaching state on a posture teach window, an operating state/shape data accumulating device is provided which stores and accumulates three-dimensional shape data outputted from a shape measuring device and robot end position information outputted from the path following device, an accumulated data inspecting device is provided which calculates various kinds of attribute information included in the three-dimensional shape data and the robot end position information according to the specification of an instructor and displays the calculation results on a data inspection window, and thus information about changes in the attributes of sensor data can be visually provided to the instructor.

In such a conventional method of teaching a path to a robot, the user has to directly edit numerical or visual information to teach position data. However, considering the promotion of robots for home use, it is not practical that the user directly edits numerical or visual information to teach position data when teaching a traveling path to a robot. Thus, a practical method of teaching a path is necessary.

An object of the present invention is to provide a method of teaching a traveling path to a robot that makes it possible to teach a path to a robot without the necessity for the user, who teaches the path, to directly edit position data.

### DISCLOSURE OF THE INVENTION

In a method of teaching a traveling path to a robot according to the present invention, when a traveling path is taught to an autonomously traveling robot, a teaching object moves, the robot monitors the position of the teaching object in time series and detects the movement of the teaching object based on data on time-series positional changes of the object, and the robot is moved according to the data on the position changes of the teaching object, and the robot detects a traveling direction and travel distance of the robot, accumulates the direction and distance in time series, and converts the direction and distance into path teaching data.

Also, in a method of teaching a traveling path to a robot according to the present invention, when a traveling path is taught to an autonomously traveling robot, a teaching object moves, the robot autonomously travels according to taught path teaching data, the robot monitors the position of the teaching object in time series, detects the movement of the teaching object based on data on time-series positional changes, and checks the traveling path of the teaching object, the robot is moved while correcting the taught path teaching data, and the robot detects a traveling direction and travel distance of the robot, accumulates the direction and distance in time series, and converts the direction and distance into path teaching data.

A robot having a function of learning a traveling path according to the present invention, comprises a position detecting unit for detecting the position of a teaching object, a movement detecting unit for monitoring the position in time series and detecting the movement of the teaching object based on data on time-series positional changes, a moving unit for moving the robot according to the data on the positional changes of the teaching object, a movement detecting unit for detecting the traveling direction and travel distance of the robot, and a data converting unit for accumulating the movement in time series and converting the traveling direction and travel distance into path teaching data.

Also, a robot having the function of learning a traveling path according to the present invention, comprises a position detecting unit for detecting the position of a teaching object, a movement detecting unit for monitoring the position in time series and detecting the movement of the teaching object based on data on time-series positional changes of the object, a moving unit for moving the robot according to taught path teaching data of the robot, and a control unit for checking the traveling path of the teaching object, moving the robot while correcting the taught path teaching data, learning the traveling path of the teaching object while correcting the taught path teaching data, and determining path teaching data.

Further, the position detecting unit for detecting the position of the teaching object detects, by using an array antenna, a signal of a transmitter carried by the teaching object, whereby the position of the teaching object is detected.

Further, the position detecting unit for detecting the position of the teaching object takes an image of the teaching object by using a camera, specifies a teaching object image in a photographing frame, and detects the position of the teaching object based on the movement of the teaching object image.

Still further, the position detecting unit for detecting the position of the teaching object detects the position of the teaching object by using a sound source direction detecting unit which comprises directivity sound input members, a signal direction detecting section, and a direction confirmation control section.

Still further, the position detecting unit for detecting the position of the teaching object detects a direction of a position where the teaching object contacts the robot, whereby the position of the teaching object is detected.

### BRIEF DESCRIPTION OF THE DRAWINGS

FIG. 1 is a structural diagram showing a specific self-propelled robot for use in a method of teaching a traveling path to the robot, according to (Embodiment 1) of the present invention;

FIG. 2 is an explanatory view showing the teaching of a path to follow according to the embodiment;

FIG. 3 is an explanatory view showing the self-propelled robot, an instructor, and teaching data according to the embodiment;

FIG. 4 is an explanatory diagram showing a principle of detecting a position according to the embodiment;

FIG. 5 is an explanatory diagram showing an assumed following operation;

FIG. 6 is an explanatory diagram showing that the position of the instructor is monitored in time series and the movement of the instructor is detected based on the time-series positional change data according to the embodiment;

FIG. 7 is an explanatory view showing that a camera is used as a position detecting unit, according to (Embodiment 2) of the present invention;

FIG. 8 is an explanatory view showing that a robot detects an instructor moving behind the robot and learns a path, according to (Embodiment 3) of the present invention;

FIG. 9 is a structural diagram showing a position detecting unit according to (Embodiment 4) of the present invention; and

FIG. 10 is a structural diagram showing a position detecting unit according to (Embodiment 5) of the present invention.

### DESCRIPTION OF THE EMBODIMENTS

A method of teaching a traveling path to a robot of the present invention will be described below in accordance with the following specific embodiments.

(Embodiment 1)

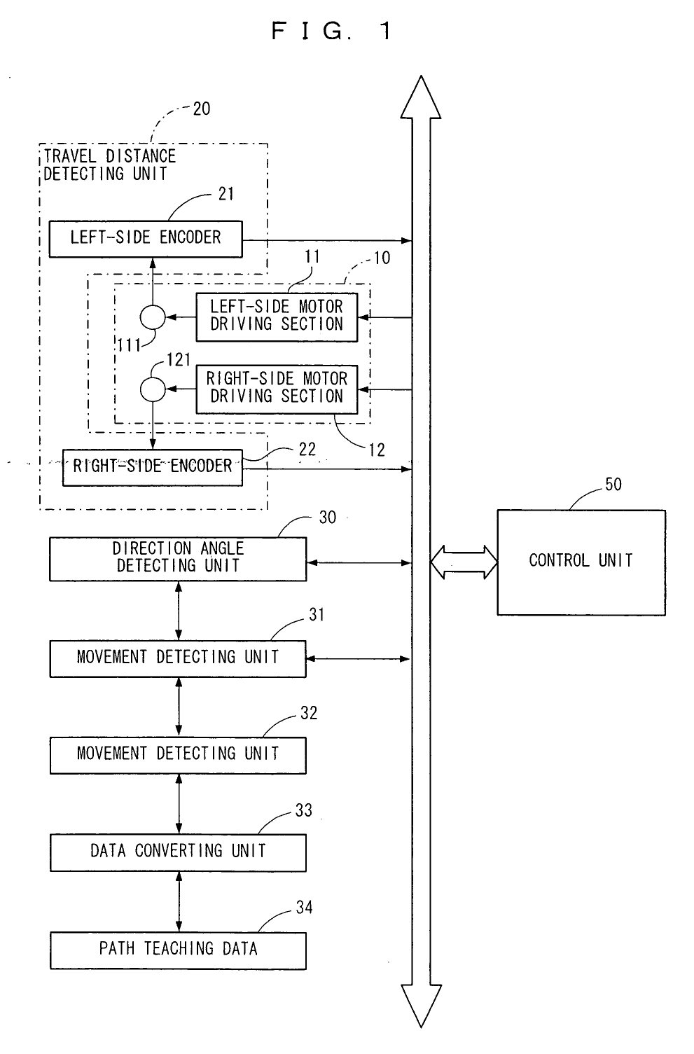

FIG. 1 shows the configuration of a self-propelled robot 1.

The self-propelled robot 1 is a robot which autonomously travels so as to follow a predetermined traveling path without the necessity for a magnetic tape or a reflection tape partially provided on a floor as a guide path.

A moving unit 10 controls the back-and-forth motion and the lateral motion of the self-propelled robot 1. The moving unit 10 is constituted of a left-side motor driving section 11 which drives a left-side traveling motor 111 to move the self-propelled robot 1 to the right and a right-side motor driving section 12 which drives a right-side traveling motor 121 to move the self-propelled robot 1 to the left. Driving wheels (not shown) are attached to the left-side traveling motor 111 and the right-side traveling motor 121.

A travel distance detecting unit 20 detects a travel distance of the self-propelled robot 1 which is moved by the moving unit 10. The travel distance detecting unit 20 is constituted of a left-side encoder 21 and a right-side encoder 22. The left-side encoder 21 generates a pulse signal proportionate to the number of revolutions of the left-side driving wheel driven by the control of the moving unit 10, that is the number of revolutions of the left-side traveling motor 111, and detects a travel distance of the self-propelled robot 1 which has moved to the right. The right-side encoder 22 generates a pulse signal proportionate to the number of revolutions of the right-side driving wheel driven by the control of the moving unit 10, that is the number of revolutions of the right-side traveling motor 121, and detects a travel distance of the self-propelled robot 1 which has moved to the left.

A control unit 50 for operating the moving unit 10 is mainly constituted of a microcomputer.

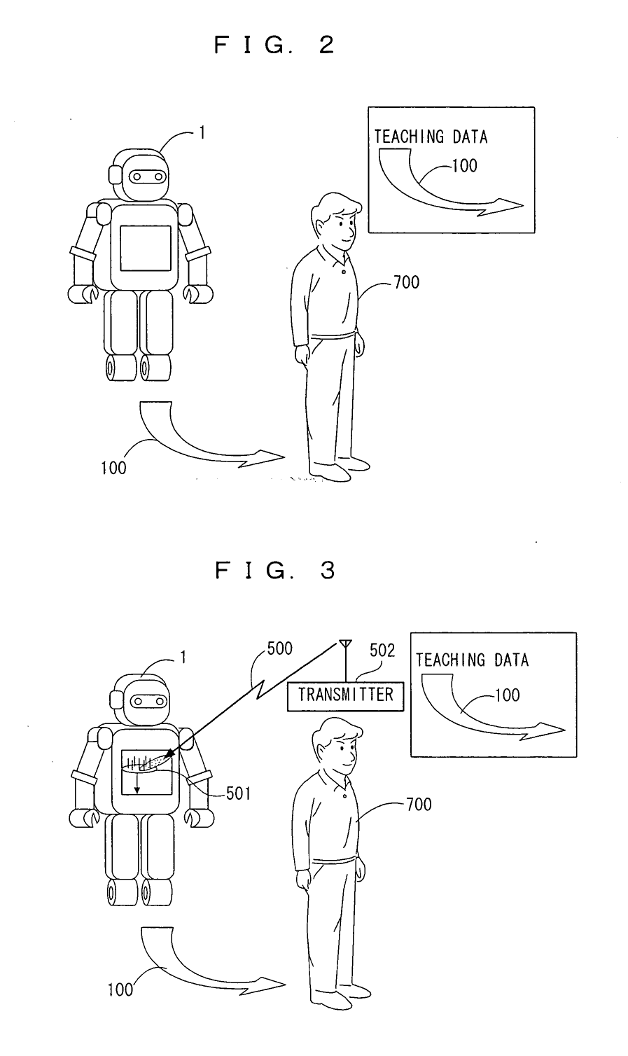

As shown in FIG. 2, (Embodiment 1) will describe an example in which the self-propelled robot 1 subjected to teaching learns a path while following an instructor 700 who moves along a path 100 to be taught. In this example, the instructor 700 who moves along the path 100 to be taught acts as a teaching object.

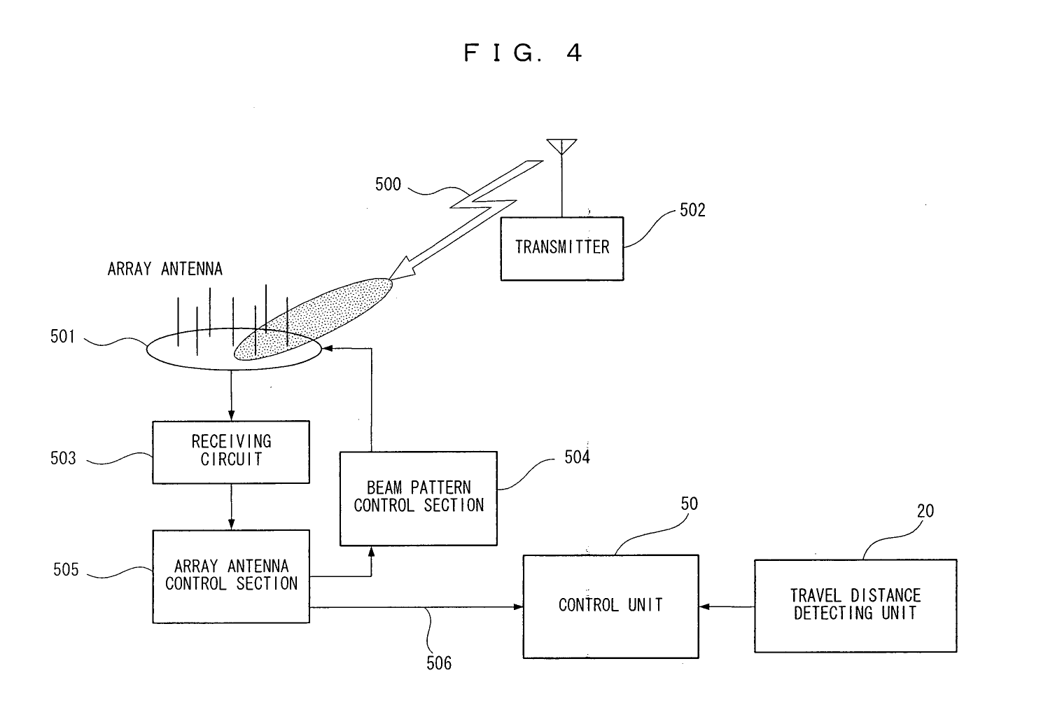

A direction angle detecting unit 30 serves as a position detecting unit for detecting the position of a teaching object. As shown in FIGS. 3 and 4, the direction angle detecting unit 30 detects, by using an array antenna 501, a signal 500 of a transmitter 502 carried by the instructor 700, and detects a change in the traveling direction of the self-propelled robot 1 driven by the moving unit 10.

To be specific, in the pickup of the signal 500, the signal 500 is received by the combination of a receiving circuit 503, an array antenna control section 505, and a beam pattern control section 504 while the receiving direction of the array antenna 501 is switched. When the receiving level reaches the maximum received signal level, a beam pattern direction is detected as the direction of the transmitter 502. Direction angle information 506 acquired thus is provided to the control unit 50.

A movement detecting unit 31 monitors direction angles detected by the direction angle detecting unit 30 in time series and detects the movement of the instructor 700 based on data on time-series direction angles. In (Embodiment 1), the time-series positions of the instructor who moves ahead are detected as changes in direction angle.

A movement detecting unit 32 moves the robot according to the movement of the instructor 700 based on the detection performed by the movement detecting unit 31, and detects the traveling direction and the travel distance of the robot from the travel distance detecting unit 20.

A data converting unit 33 accumulates movement data in time series and converts the data into path teaching data 34.

In a period during which the traveling path is taught, the control unit 50 reads the travel distance data detected by the travel distance detecting unit 20 and the traveling direction data detected by the direction angle detecting unit 30 at each predetermined time, calculates the current position of the self-propelled robot 1, controls the traveling of the self-propelled robot 1 according to the information results, and performs operation control so that the self-propelled robot 1 follows the traveling path of the instructor.

When teaching is completed and the path teaching data 34 is determined (when learning is completed), the control unit 50 performs operation control as that a target path is followed according to the path teaching data 34 and traveling is accurately carried out to a target point without deviating from a normal track.

In this way, when the self-propelled robot 1 learns a traveling path, automatic processing is performed as follows: the instructor 700 only follows the traveling path, and the self-propelled robot 1 set at a learning mode follows the traveling path 100 of the instructor 700 and determines the path teaching data 34. Thus, it is possible to teach a path to the robot without the necessity for the instructor 700 to directly edit position data.

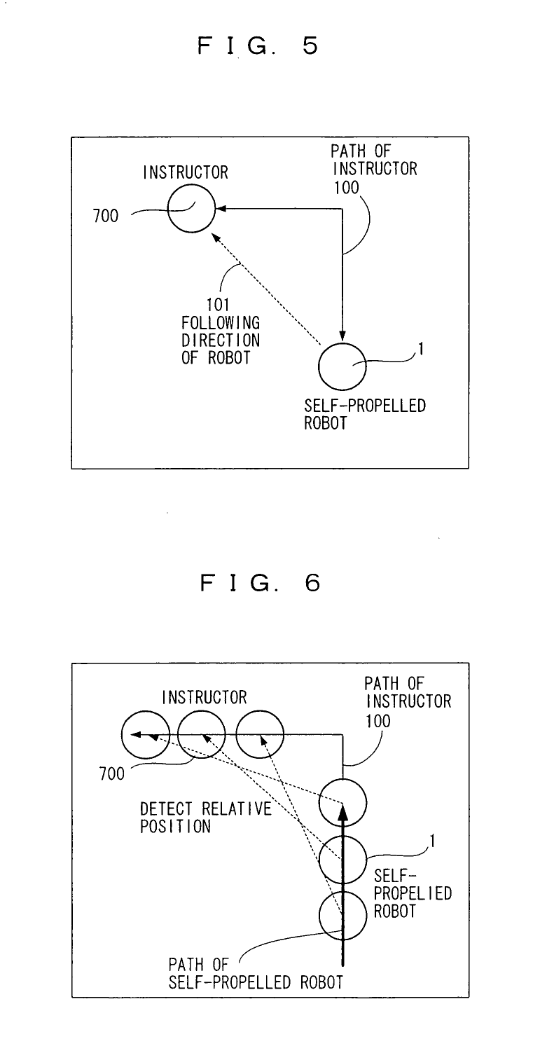

As shown in FIG. 5, when the self-propelled robot 1 set at the learning mode follows the traveling path 100 of the instructor along a direction 101 at the shortest distance, accurate teaching cannot be performed. With the control section 50, as shown in FIG. 6, the self-propelled robot 1 first stores the directions and distances of the instructor 700 in a sequential manner, and the self-propelled robot 1 simultaneously calculates the positions (xy coordinates) of the instructor based on the directions and the distances and stores the positions. Then, the self-propelled robot 1 detects the relative positions of the stored position data string, and calculates change points along the direction of the path 100 based on time-series positions shown in FIG. 6 instead of the direction 101 at the shortest distance shown in FIG. 5. The self-propelled robot 1 determines and stores the change points as a path to be learned. Thus, the self-propelled robot 1 can autonomously travel accurately along the traveling path 100 of the instructor 700.

(Embodiment 2)

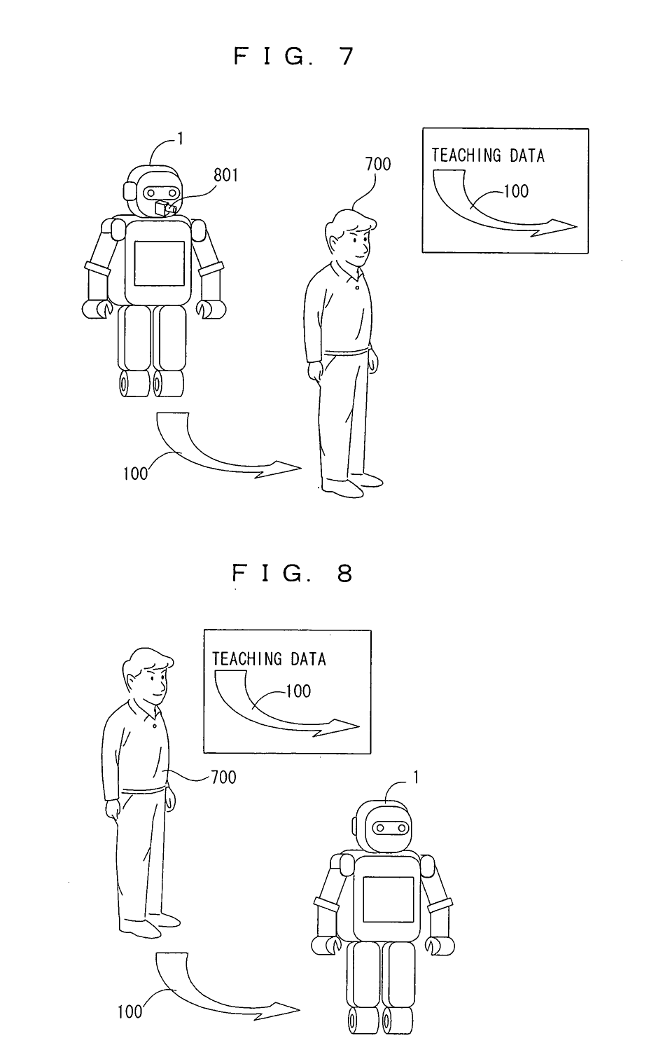

In (Embodiment 1), the position detecting unit detects, as a change in azimuth angle, the position of the transmitter 502 carried by the instructor 700 in a state in which the array antenna 501 is mounted in the self-propelled robot 1. (Embodiment 2) is different only in that a camera 801 is mounted on a self-propelled robot 1 as shown in FIG. 7 to take an image of an instructor 700 who moves ahead, the image of the instructor 700 (instructor image) is specified on the taken image, and a change in the position of the instructor 700 on the image is converted into a direction angle. Besides, in order to specify a taken image of the instructor 700, the instructor 700 wears, for example, a jacket with a fluorescent-colored marking.

In this way, even when the camera 801 is used as a position detecting unit for detecting the position of the instructor who moves ahead, a traveling path can be similarly taught to the self-propelled robot 1.

(Embodiment 3)

In the above-described embodiments, the self-propelled robot 1 autonomously travels so as to follow the instructor 700 and learns teaching data. The configuration of FIG. 8 is also applicable: the self-propelled robot 1 travels ahead of an instructor 700 according to taught path teaching data, monitors the position of the instructor 700, who travels behind, in time series by using the array antenna of (Embodiment 1) or the camera 801 of (Embodiment 2), detects the movement of the instructor based on data on time-series positional changes of the instructor, moves the self-propelled robot 1 according to the movement of the instructor, compares the movement of the instructor with the taught path teaching data to check whether or not the instructor follows the robot along the traveling path, learns the traveling path of the instructor and performs automatic processing while correcting the taught path teaching data, and determines path teaching data 34.

(Embodiment 4)

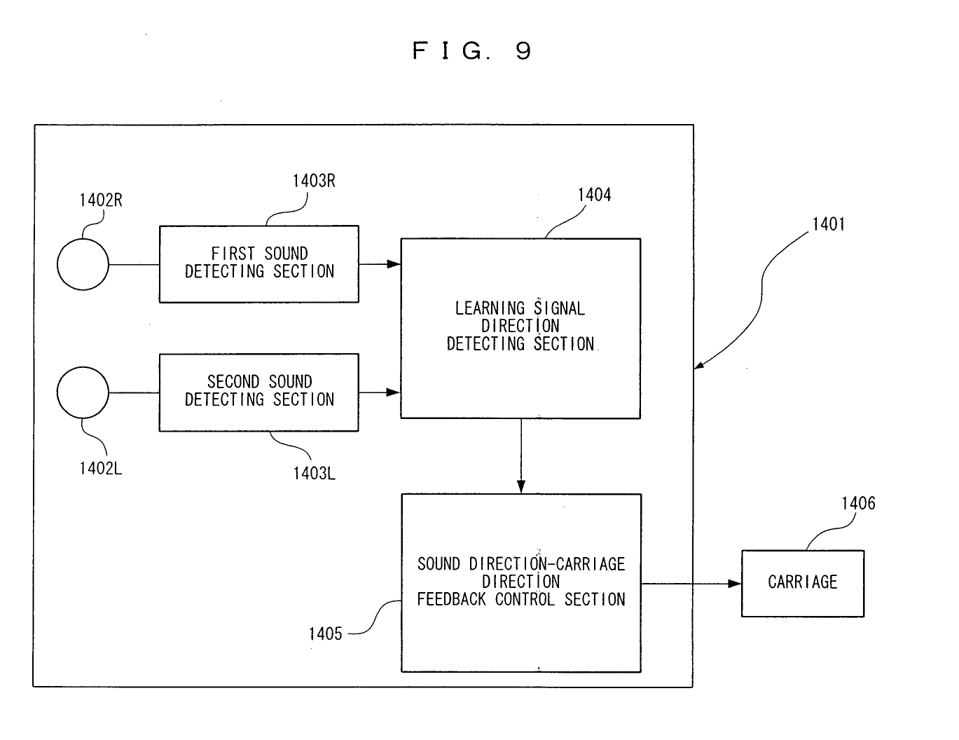

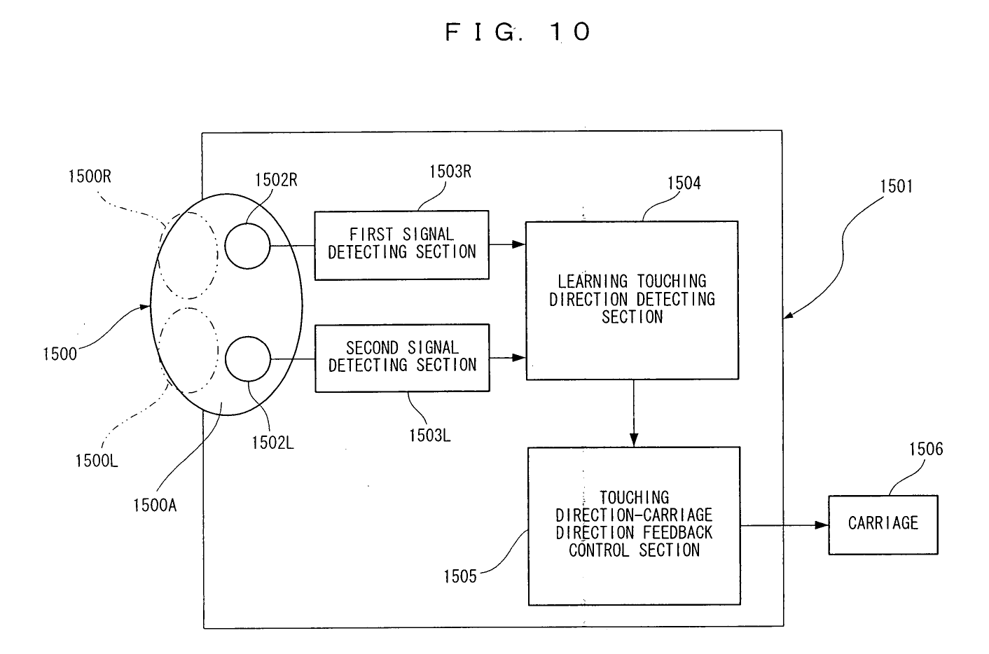

FIG. 9 shows (Embodiment 4) which is different from the above-described embodiments only in the configuration of a position detecting unit for detecting the position of a teaching object.

In this case, a sound source direction detector 1401 serving as a position detecting unit is mounted on the self-propelled robot 1 which is subjected to teaching. An instructor 700 serving as a teaching object moves along a traveling path to be taught while uttering a predetermined teaching phrase (e.g. “come here”).

The sound source direction detector 1401 is constituted of microphones 1402R and 1402L, each serving as a directivity sound input member, first and second sound detecting sections 1403R and 1403L, a learning signal direction detecting section 1404 serving as a signal direction detecting section, and a sound direction-carriage direction feedback control section 1405 serving as a direction confirmation control section.

The microphone 1402R and the microphone 1402L detect ambient sound and the first sound detecting section 1403R detects only the sound component of the teaching phrase from the sound detected by the microphone 1402R. The second sound detecting section 1403L detects only the sound component of the teaching phrase from the sound detected by the microphone 1402L.

The learning signal direction detecting section 1404 performs signal pattern matching in each direction and removes a phase difference in each direction. Further, the learning signal direction detecting section 1404 extracts a signal intensity from a sound matching pattern, adds microphone orientation information, and performs direction vectorization.

At this point of time, the learning signal direction detecting section 1404 performs learning beforehand based on the basic pattern of a sound source direction and a direction vector and stores learning data therein. Further, in the case of insufficient accuracy of detecting a sound source, the learning signal direction detecting section 1404 finely moves (rotates) the self-propelled robot 1, detects a direction vector at an approximate angle, and averages the direction vector, so that accuracy is improved.

A carriage 1406 of the self-propelled robot 1 is driven based on the detection results of the learning signal direction detecting section 1404 via the sound direction-carriage direction feedback control section 1405, and the self-propelled robot 1 is moved in the incoming direction of the teaching phrase uttered by the instructor. Hence, as with (Embodiment 1), the traveling direction and the travel distance of the robot are detected from a traveling distance detecting unit 20, and a data converting unit 33 accumulates movement data in time series and converts the data into path teaching data 34.

(Embodiment 5)

FIG. 10 shows (Embodiment 5) which is different from the above-described embodiments only in the configuration of a position detecting unit for detecting the position of a teaching object.

FIG. 10 shows a touching direction detecting unit 1501 which is mounted on a self-propelled robot 1 instead of the sound source direction detecting unit. The touching direction detecting unit 1501 decides a state of a teaching touch performed by an instructor on the touching direction detecting unit 1501 and detects the position of the instructor.

A touching direction sensor 1500 mounted on the self-propelled robot 1 is constituted of a plurality of strain gauges, e.g., 1502R and 1502L attached to a deformable body 1500A, just like a load cell device known as a weight sensor. When an area 1500R of the deformable body 1500A is touched, the strain gauge 1502R detects greater strain than that of the strain gauge 1502L. When an area 1501L of the deformable body 1500A is touched, the strain gauge 1502L detects greater strain than the strain gauge 1502R. Besides, at least a part of the deformable body 1500A is exposed from the body of the self-propelled robot 1.

In a learning touching direction detecting section 1504, signals detected by the strain gauges 1502R and 1502L are received via first and second signal detecting sections 1503R and 1503L and the input signals are separately subjected to signal pattern matching to detect a peak signal. Further, a plurality of peak signal patterns are subjected to matching to perform direction vectorization.

The learning touching direction detecting section 1504 learns the basic pattern of a touching direction and a direction vector beforehand and stores learning data therein.

A carriage 1506 of the self-propelled robot 1 is driven based on the detection results of the learning touching direction detecting section 1504 via a touching direction-carriage direction feedback control section 1505 to move the self-propelled robot 1 along the direction of a touch made by the instructor on the deformable body 1500A.

Hence, as with (Embodiment 1), the traveling direction and the travel distance of the robot are detected from a traveling distance detecting unit 20, and a data converting unit 33 accumulates movement data in time series and converts the data into path teaching data 34.

In (Embodiment 5), a plurality of strain gauges are attached to the deformable body 1500A to constitute the touching direction sensor 1500. A plurality of strain gauges may be attached to the body of the self-propelled robot 1 to constitute the touching direction sensor 1500.

As described above, according to the method of teaching a traveling path to a robot of the present invention, the robot learns a traveling path while detecting a teaching object moving along the traveling path to be taught, and performs automatic processing to determine path teaching data. Thus, an instructor does not have to directly edit position data, achieving more practical teaching of a path as compared with the conventional art.

Further, the directivity sound input members, the signal direction detecting section, and the direction confirmation control section are provided as the position detecting unit for detecting the position of a teaching object, and the position of the teaching object is detected by the sound source direction detecting unit. Also in this configuration, the robot learns a traveling path while detecting the teaching object who utters a teaching phrase and moves along the traveling path to be taught, and the robot performs automatic processing to determine path teaching data. Thus, an instructor does not have to directly edit position data, achieving more practical teaching of a path as compared with the conventional art.

Moreover, as the position detecting unit for detecting the position of a teaching object, a direction of a contact made by a teaching object on the robot is detected and the position of the teaching object is detected. In this configuration, the teaching object only has to touch the moving robot so as to indicate a direction of approaching a traveling path to be taught, and the robot detects and learns the teaching path and performs automatic processing to determine path teaching data. Thus, an instructor does not have to directly edit position data, achieving more practical teaching of a path as compared with the conventional art.

What is claimed is:

1. A method of teaching a traveling path to a robot, wherein in teaching a traveling path to an autonomously traveling robot,
a teaching object moves, the robot monitors a position of the teaching object in time series and detects a movement of the teaching object based on data on time-series positional changes, and the robot moves according to the data on positional changes of the teaching object, and
the robot detects a traveling direction and travel distance of the robot, accumulates the direction and distance in time series, and converts the direction and distance into path teaching data.

2. A method of teaching a traveling path to a robot, wherein in teaching a traveling path to an autonomously traveling robot,
a teaching object moves, the robot autonomously travels according to taught path teaching data,
the robot monitors a position of the teaching object in time series, detects a movement of the teaching object based on data on time-series positional change of the object, and checks the traveling path of the teaching object, and the robot moves while correcting the taught path teaching data, and
the robot detects a traveling direction and travel distance of the robot, accumulates the direction and distance in time series, and converts the direction and distance into path teaching data.

3. A robot having a function of learning a traveling path, comprising:
a position detecting unit for detecting a position of a teaching object;
a movement detecting unit for monitoring the position of the teaching object in time series and detecting a movement of the teaching object based on data on time-series positional changes;
a moving unit for moving the robot according to the data on positional changes of the teaching object;
a movement detecting unit for detecting a traveling direction and travel distance of the robot; and
a data converting unit for accumulating the movement in time series and converting the movement into path teaching data.

4. A robot having a function of learning a traveling path, comprising:
a position detecting unit for detecting a position of a teaching object;
a movement detecting unit for monitoring the position of the teaching object in time series and detecting a movement of the teaching object based on data on time-series positional changes of the object;
a moving unit for moving the robot according to taught path teaching data of the robot; and
a control unit for checking a traveling path of the teaching object, moving the robot while correcting the taught path teaching data, learning the traveling path of the teaching object while correcting the taught path teaching data, and determining the path teaching data.

5. The robot having a function of learning a traveling path according to claim 3 or 4, wherein the position detecting unit for detecting a position of the teaching object detects, by using an array antenna, a signal of a transmitter carried by the teaching object, whereby the position of the teaching object is detected.

6. The robot having a function of learning a traveling path according to claim 3 or 4, wherein the position detecting unit for detecting a position of the teaching object takes an image of the teaching object by using a camera, specifies a teaching object image in a photographing frame, and detects the position of the teaching object based on a movement of the teaching object image.

7. The robot having a function of learning a traveling path according to claim 3 or 4, wherein the position detecting unit for detecting a position of the teaching object detects the position of the teaching object by using a sound source direction detecting unit comprising a directivity sound input member, a signal direction detecting section, and a direction confirmation control section.

8. The robot having a function of learning a traveling path according to claim 3 or 4, wherein the position detecting unit for detecting a position of the teaching object detects a direction of a position where the teaching object contacts the robot, whereby the position of the teaching object is detected.
